(19) United States
(12) Patent Application Publication
(10) Pub. No.: US 2021/0117114 A1
(43) Pub. Date: Apr. 22, 2021

(54) MEMORY SYSTEM FOR FLEXIBLY ALLOCATING MEMORY FOR MULTIPLE PROCESSORS AND OPERATING METHOD THEREOF

(71) Applicant: SAMSUNG ELECTRONICS CO., LTD., Suwon-si (KR)

(72) Inventor: Dongsik Cho, Suwon-si (KR)

(73) Assignee: SAMSUNG ELECTRONICS CO., LTD., Suwon-si (KR)

(21) Appl. No.: 16/905,305

(22) Filed: Jun. 18, 2020

(30) Foreign Application Priority Data
Oct. 18, 2019 (KR) 10-2019-0129962

(51) Int. Cl. G06F 3/06

(52) U.S. Cl. CPC G06F 3/0631; G06F 3/0665; G06F 3/0683; G06F 3/0644; G06F 3/0611; G06F 3/0659

(57) ABSTRACT

A memory system includes a memory device that includes a plurality of memory units, a first memory controller that accesses the plurality of memory units, a second memory controller that accesses the plurality of memory units, a memory allocator that, based on set signals, connects a first memory unit of the plurality of memory units to the first memory controller and a second memory unit of the plurality of memory units to the second memory controller, a first processor that uses the first memory unit through the first memory controller, and a second processor that uses the second memory unit through the second memory controller.

### CROSS-REFERENCE TO RELATED APPLICATION

This application claims priority under 35 U.S.C. § 119 from Korean Patent Application No. 10-2019-0129962, filed on Oct. 18, 2019 in the Korean Intellectual Property Office, the disclosure of which is incorporated by reference herein in its entirety.

### BACKGROUND

Apparatuses and methods consistent with exemplary embodiments relate to a semiconductor device, and more particularly, to a memory system for flexibly allocating a memory to a plurality of processors and an operating method thereof.

A memory system may be implemented with one product or chip including two or more subsystems. For example, the memory system may be implemented with one product or chip including two or more of an application processing system, a communication system, a navigation system, a voice recognition system, a context hub system, and an audio system. In this case, each of the subsystems may operate based on at least one processor. That is, the memory system may include two or more processors.

The memory system may include an internal memory storing data to be processed by processors or data processed by the processors. The memory system may allocate a memory to each of the processors within a given size of the internal memory, depending on a demand of a client (or solution). In this case, memory sizes that are required with respect to the processors may be different for respective clients. In the case of increasing the size of the internal memory for the purpose of satisfying demands of all the clients, costs for implementing the memory system may increase. As such, there is required a memory system for allocating a memory flexibly to processors based on an internal memory having an appropriate size.

### SUMMARY

One or more exemplary embodiments provide a memory system for allocating a memory flexibly to processors based on an internal memory having an appropriate size.

According to an aspect of an exemplary embodiment, a memory system includes: a memory device that includes a plurality of memory units; a first memory controller configured to access the plurality of memory units; a second memory controller configured to access the plurality of memory units; a memory allocator configured to, based on set signals, connect a first memory unit of the plurality of memory units to the first memory controller and connect a second memory unit of the plurality of memory units to the second memory controller; a first processor configured to use the first memory unit through the first memory controller; and a second processor configured to use the second memory unit through the second memory controller.

According to an aspect of another exemplary embodiment, a memory system includes: a memory device that includes a plurality of memory units; a plurality of memory controllers configured to access the plurality of memory units; a plurality of processors configured to use the memory device through a corresponding memory controller among the plurality of memory controllers; and a memory allocator configured to, based on set signals, connect at least one memory unit among the plurality of memory units to a first memory controller among the plurality of memory controllers, wherein a first processor among the plurality of processors is configured to use the at least one memory unit through the first memory controller.

According to an aspect of another exemplary embodiment, an operating method of a memory system that includes a plurality of memory controllers capable of accessing a plurality of memories, each having a pre-set size, and a plurality of processors includes: obtaining required memory information about each of the plurality of processors; allocating, based on the required memory information, a first memory among the plurality of memories to a first processor of the plurality of processors; and generating, at a first memory controller corresponding to the first processor from among the plurality of memory controllers, mapping information between the allocated first memory and a virtual memory recognized by the first processor.

### BRIEF DESCRIPTION OF THE FIGURES

The above and other objects and features will become apparent by describing in detail exemplary embodiments thereof with reference to the accompanying drawings, of which:

FIG. 1 illustrates a block diagram of a memory system according to an exemplary embodiment;

FIGS. 2A and 2B illustrate examples of a memory device of FIG. 1 for allocating a memory to subsystems according to one or more exemplary embodiments;

FIG. 3 illustrates an example of a detailed block diagram of a memory system according to an exemplary embodiment;

FIG. 4 illustrates an exemplary block diagram of a memory allocator of FIG. 3;

FIG. 5 illustrates an example of memory allocation by a memory allocator of FIG. 4;

FIG. 6 is a diagram for describing an operation of a memory controller of a memory system of FIG. 3;

FIGS. 7A and 7B illustrate examples of operations of memory controllers of FIG. 3 according to an operation of a memory controller of FIG. 6;

FIG. 8 is a flowchart illustrating an exemplary operation of a memory system of FIG. 3;

FIG. 9 is a flowchart illustrating a write operation of a memory controller of FIG. 3;

FIG. 10 is an example illustrating a write operation of a memory system of FIG. 3 according to an operation of FIG. 9;

FIG. 11 is a flowchart illustrating a read operation of a memory controller of FIG. 3;

FIG. 12 is an example illustrating a read operation of a memory system of FIG. 3 according to an operation of FIG. 11; and

FIG. 13 is a block diagram illustrating an electronic device including a memory system according to an exemplary embodiment.

### DETAILED DESCRIPTION

Below, exemplary embodiments of the inventive concept(s) may be described in detail and clearly to such an extent that one of ordinary skill in the art can easily implement the inventive concept(s).

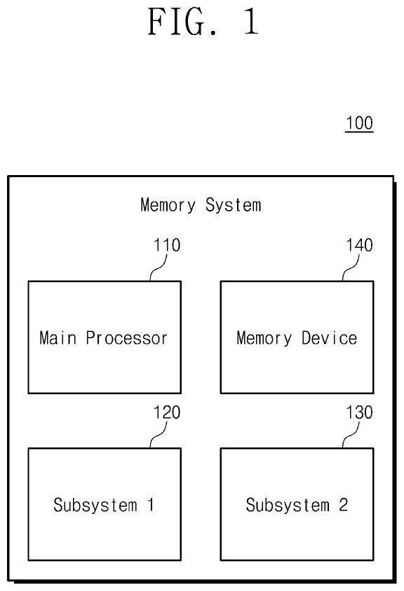

FIG. 1 illustrates a block diagram of a memory system 100 according to an exemplary embodiment. Referring to FIG. 1, a memory system 100 may include a main processor 110, a first subsystem 120, a second subsystem 130, and a memory device 140. For example, the memory system 100 may be applied to electronic devices such as a desktop computer, a laptop computer, a tablet computer, a smartphone, a wearable device, a vehicle, a server. While two subsystems 120 and 130 are illustrated in FIG. 1, it is understood that one or more other exemplary embodiments are not limited thereto. For example, the number of subsystems included in the memory system 100 may vary and be greater than two. The memory system 100 may further include various semiconductor components. For example, the memory system 100 may be implemented with a system on chip SoC in which components are integrated in the form of one chip.

The main processor 110 may control overall operations of the memory system 100. For example, the main processor 110 may control the subsystems 120 and 130 and the memory device 140. In an exemplary embodiment, the main processor 110 may perform various kinds of arithmetic operations and/or logical operations. The main processor 110 may provide data generated as a result of the operations to the memory device 140.

In the example illustrated in FIG. 1, the main processor 110 is independent of the subsystems 120 and 130, but it is understood that one or more other exemplary embodiments are not limited thereto. For example, according to another exemplary embodiment, the main processor 110 may also be one of various subsystems of the memory system 100. By way of example, the main processor 110 may be included in an upper subsystem that controls the subsystems 120 and 130.

Each of the subsystems 120 and 130 may process data under control of the main processor 110. In an exemplary embodiment, each of the subsystems 120 and 130 may include a dedicated processor that performs a particular function based on various kinds of arithmetic operations and/or logical operations. For example, each of the subsystems 120 and 130 may include at least one dedicated processor that operates as one of an application processing system, a navigation system, a voice recognition system, a context hub system, an audio system, an image processing system, a neuromorphic system, etc. Each of the subsystems 120 and 130 may provide data generated as a result of the operations to the memory device 140.

The memory device 140 may store data that is used for an operation of the memory system 100. In an exemplary embodiment, the memory device 140 may temporarily store data processed or to be processed by the main processor 110 and/or the subsystems 120 and 130. The memory device 140 may include a volatile memory, such as a static random access memory (SRAM), a dynamic RAM (DRAM), a synchronous DRAM (SDRAM), etc., and/or a nonvolatile memory, such as a flash memory, a phase-change RAM (PRAM), a resistive RAM (ReRAM), a ferro-electric RAM (FRAM), etc.

In an exemplary embodiment, the memory system 100 may allocate a memory to the main processor 110 and the subsystems 120 and 130 within a given size of the memory device 140 depending on a demand of a client (or solution). In this case, memory sizes that are required, used, or allocated with respect to the respective components may be different for respective clients. For example, with regard to the first subsystem 120, a memory size that a first client requires or uses may be different from a memory size that a second client requires or uses. The memory system 100 may allocate a memory flexibly to the main processor 110 and the subsystems 120 and 130 based on the memory device 140 having a given size.

In the example illustrated in FIG. 1, the memory device 140 is independent of the subsystems 120 and 130. It is understood, however, that one or more other exemplary embodiments are not limited thereto. For example, the memory device 140 may be included in one of the subsystems 120 and 130. In this case, the other of the subsystems 120 and 130 may access the memory device 140 included in the one subsystem.

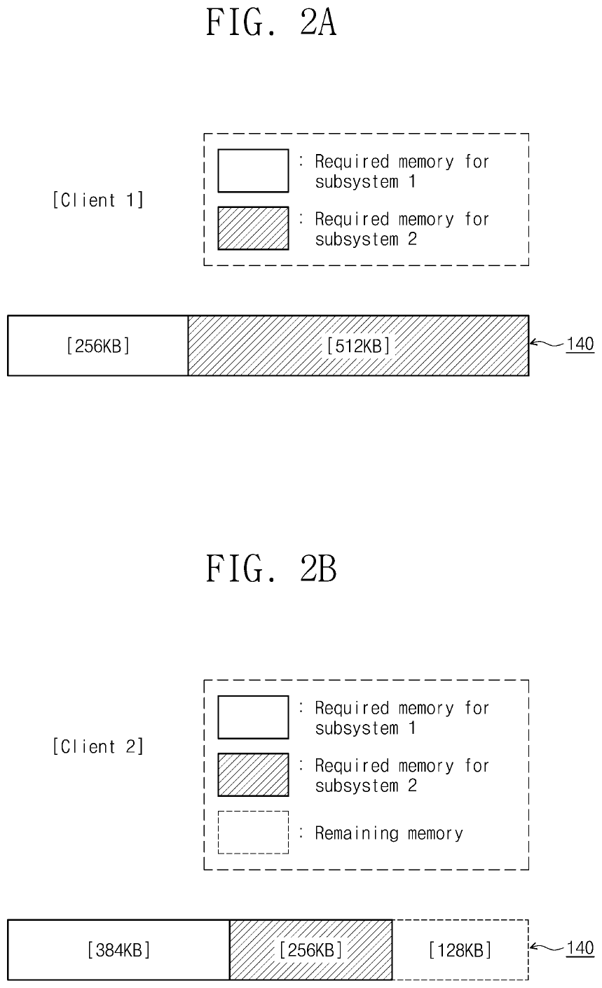

FIGS. 2A and 2B illustrate examples of a memory device 140 of FIG. 1 for allocating a memory to subsystems according to one or more exemplary embodiments. For convenience of description, it is assumed that the memory device 140 of FIG. 1 is used only by the subsystems 120 and 130. Referring to FIGS. 2A and 2B, with regard to the first subsystem 120, the first client may require a memory of 256 KB, and the second client may require a memory of 384 KB. With regard to the second subsystem 130, the first client may require a memory of 512 KB, and the second client may require a memory of 256 KB. As such, the first client may require a total memory of 768 KB with respect to the subsystems 120 and 130, and the second client may require a total memory of 640 KB with respect to the subsystems 120 and 130.

To satisfy the demands of the first and second clients, the memory device 140 may be implemented to have a maximum size from among the total memory size required by the first client and the total memory size required by the second client. Because the total memory size required by the first client is greater than the total memory size required by the second client, the memory device 140 may be implemented to have a memory of 768 KB.

Depending on the demand of the first client, within the given size (i.e., 768 KB) of the memory device 140, the memory system 100 may allocate 256 KB to the first subsystem 120 and may allocate 512 KB to the second subsystem 130. Depending on the demand of the second client, within the given size (i.e., 768 KB) of the memory device 140, the memory system 100 may allocate 384 KB to the first subsystem 120 and may allocate 256 KB to the second subsystem 130. In the case of allocating a memory depending on the demand of the second client, 128 KB of the memory device 140 may remain.

As described above, the memory device 140 may be implemented to have a maximum value among memory sizes that a plurality of clients require. In this case, the demands of all the clients may be satisfied, and the size of the memory device 140 may be minimized. Accordingly, the costs for the memory system 100 including the memory device 140 may be reduced, and an increase in the area of the memory system 100 due to the memory device 140 may be minimized.

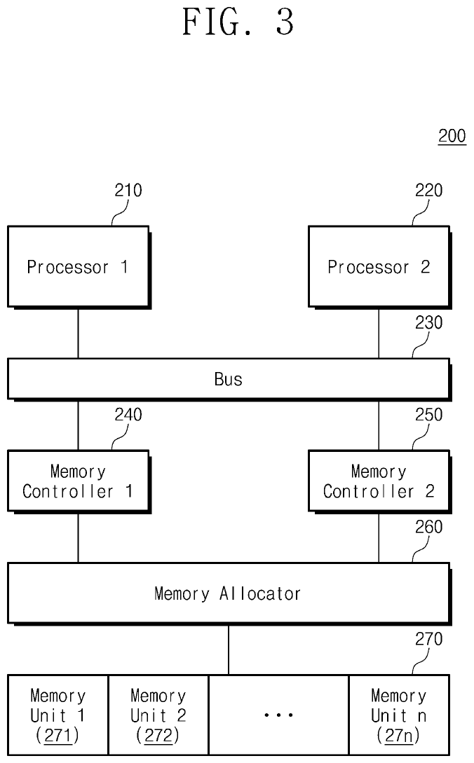

FIG. 3 illustrates an example of a detailed block diagram of a memory system 200 according to an exemplary embodiment. Referring to FIG. 3, a memory system 200 may include a first processor 210, a second processor 220, a bus 230, a first memory controller 240, a second memory controller 250, a memory allocator 260, and a memory device 270.

Each of the processors 210 and 220 may perform various kinds or types of arithmetic operations or logical operations. The processors 210 and 220 may perform different functions or may perform the same function. For example, the processors 210 and 220 may be included in the subsystems 120 and 130 of FIG. 1, respectively. Alternatively, one of the processors 210 and 220 may be the main processor 110 of FIG. 1, and the other of the processors 210 and 200 may be included in one of the subsystems 120 and 130. It is understood, however, that these are merely examples and one or more other exemplary embodiments are not limited thereto. For example, the processors 210 and 220 may be different processors included in one subsystem.

The bus 230 may provide a communication path between the processors 210 and 220 and any other component. For example, the first processor 210 may communicate with the first memory controller 240 through the bus 230, and the second processor 220 may communicate with the second memory controller 250 through the bus 230.

The first memory controller 240 may control operations of the memory device 270 under control of the corresponding processor. For example, the first memory controller 240 may correspond to the first processor 210. In this case, in response to a control signal from the first processor 210, the first memory controller 240 may write data in the memory device 270 or may read data from the memory device 270.

The second memory controller 250 may control operations of the memory device 270 under control of the corresponding processor. For example, the second memory controller 250 may correspond to the second processor 220. In this case, in response to a control signal from the second processor 220, the second memory controller 250 may write data (or control to write data) in the memory device 270 or may read data (or control to read data) from the memory device 270.

The memory allocator 260 may allocate a memory of the memory device 270 to each of the processors 210 and 220 under control of a main processor (e.g., the main processor 110 of FIG. 1). In the case where the first processor 210 or the second processor 220 operates as a main processor, the memory allocator 260 may allocate a memory of the memory device 270 to each of the processors 210 and 220 under control of the first processor 210 or the second processor 220. In this case, a memory size to be allocated to each of the processors 210 and 220 may vary depending on a demand of a client.

In an exemplary embodiment, the memory allocator 260 may connect the memory controllers 240 and 250 and the memory device 270 such that a processor accesses an allocated memory through the corresponding memory controller. For example, the memory allocator 260 may select a communication path between the first memory controller 240 and the allocated memory such that the first processor 210 accesses the allocated memory through the first memory controller 240. That is, the memory allocator 260 may establish other communication paths between the memory controllers 240 and 250 and the memory device 270 depending on a demand of a client.

Under control of the memory controllers 240 and 250, the memory device 270 may store data or may output the stored data. The memory device 270 may include a volatile memory, such as a static random access memory (SRAM), a dynamic RAM (DRAM), a synchronous DRAM (SDRAM), etc., and/or a nonvolatile memory, such as a flash memory, a phase-change RAM (PRAM), a resistive RAM (ReRAM), a ferro-electric RAM (FRAM), etc. For example, the memory device 270 may correspond to the memory device 140 of FIG. 1. As described above with reference to FIGS. 2A and 2B, the total memory size of the memory device 270 may correspond to a maximum value of the total memory sizes that a plurality of clients require.

The memory device 270 may include a plurality of memory units 271 to 27n. Each of the memory units 271 to 27n may include a set of memory cells. In this case, each of the memory cells may have a given (e.g., pre-set) size. The memory units 271 to 27n may be memories having different sizes. Alternatively, at least two of the memory units 271 to 27n may be memories having the same size. For example, the memory units 271 to 27n may be implemented with memories of 4 BK, 8 KB, 16 KB, 32 KB, 64 KB, etc., but the inventive concept(s) is not limited thereto.

In an exemplary embodiment, a memory of the memory device 270 may be allocated to the processors 210 and 220 in units of a memory unit. For example, at least one of the memory units 271 to 27n may be allocated to the first processor 210. In this case, at least one of the remaining memory units other than the memory unit allocated to the first processor 210 may be allocated to the second processor 220. As such, each of the processors 210 and 220 may use an allocated memory unit through the corresponding memory controller.

As described above, the processors 210 and 220 of the memory system 200 may use allocated memories of the memory device 270 through the memory controllers 240 and 250. For example, the first processor 210 may use the allocated memory of the memory device 270 through the first memory controller 240, and the second processor 220 may use the allocated memory of the memory device 270 through the memory controller 250. In this case, each of the memory controllers 240 and 250 may access only an allocated memory unit of the memory units 271 to 27n by the memory allocator 260.

Each of the memory controllers 240 and 250 may access all the memory units 271 to 27n of the memory device 270, and a memory unit that each of the memory controllers 240 and 250 actually accesses may change depending on a demand of a client. Accordingly, the memory system 200 may flexibly allocate the memory of the memory device 270 to the processors 210 and 220 depending on a demand of a client.

FIG. 3 illustrates an example in which the memory system 200 includes the two processors 210 and 220 and the two memory controllers 240 and 250, but this is only an exemplary configuration for describing the memory system 200. One or more other exemplary embodiments may be applied to a memory system including processors, the number of which is variously determined, and memory controllers, the number of which is variously determined.

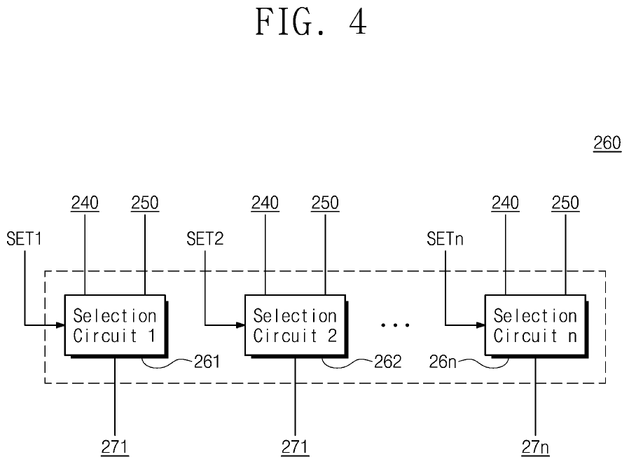

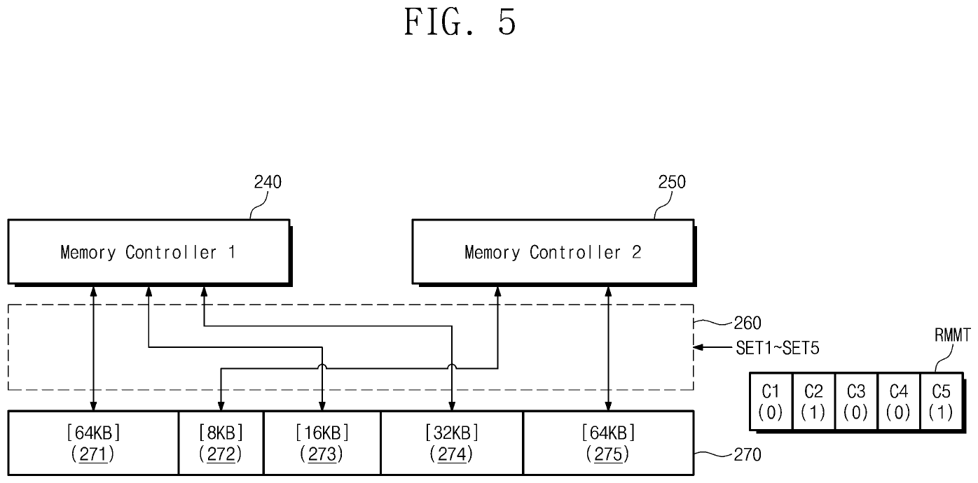

Below, the memory allocator 260 will be described in detail with reference to FIGS. 4 to 5.

FIG. 4 illustrates an exemplary block diagram of a memory allocator 260 of FIG. 3. Referring to FIG. 4, the memory allocator 260 may include first to n-th selection circuits 261 to 26n. The selection circuits 261 to 26n may correspond to the memory units 271 to 27n, respectively. For example, the first selection circuit 261 may correspond to the first memory unit 271, and the second selection circuit 262 may correspond to the second memory unit 272.

The selection circuits 261 to 26n may respectively receive first to n-th set signals SET1 to SETn. For example, the first selection circuit 261 may receive the first set signal SET1, the second selection circuit 262 may receive the second set signal SET2, etc. The set signals SET1 to SETn may be control signals for allocating a memory to the processors 210 and 220 of FIG. 3. As such, values of the set signals SET1 to SETn may vary depending on a demand of a client.

For example, the set signals SET1 to SETn may be provided from a main processor (e.g., the main processor 110 of FIG. 1) that controls overall operations of the memory system 200 depending on a demand of a client. The set signals SET1 to SETn may be stored and managed in a particular register (e.g., an always-on memory) of the memory system 200. It is understood, however, that one or more other exemplary embodiments are not limited thereto. For example, according to another exemplary embodiment, the set signals SET1 to SETn may be stored and managed in an internal register of the memory allocator 260.

The selection circuits 261 to 26n may connect the memory controllers 240 and 250 with the memory units 271 to 27n based on the set signals SET1 to SETn. That is, the selection circuits 261 to 26n may select (or establish) communication paths between the memory controllers 240 and 250 and the memory units 271 to 27n. For example, the first selection circuit 261 may connect one of the memory controllers 240 and 250 with the first memory unit 271 based on the first set signal SET1. In this case, the first memory unit 271 may communicate with a memory controller 240 or 250 connected through the first selection circuit 261. For example, the second selection circuit 262 may connect one of the memory controllers 240 and 250 with the second memory unit 272 based on the second set signal SET2. In this case, the second memory unit 272 may communicate with a memory controller 240 or 250 connected through the second selection circuit 262.

As described above, the memory allocator 260 may allocate a memory to the processors 210 and 220 by connecting the memory controllers 240 and 250 and the memory units 271 to 27n based on the set signals SET1 to SETn.

FIG. 5 illustrates an example of memory allocation by a memory allocator 260 of FIG. 4. Referring to FIG. 5, the memory device 270 may include first to fifth memory units 271 to 275. Memory sizes of the memory units 271 to 275 may be 64 KB, 8 KB, 16 KB, 32 KB, and 64 KB. That is, the total memory size of the memory device 270 may be 184 KB.

The memory allocator 260 may establish communication paths between the memory controllers 240 and 250 and the memory units 271 to 275 based on the first to fifth set signals SET1 to SETS. For example, the set signals SET1 to SETS may be 0, 1, 0, 0, and 1. Here, “0” may indicate the first memory controller 240, and “1” may indicate the second memory controller 250. The memory allocator 260 may connect the first memory controller 240 and the first memory unit 271 based on the first set signal SET1 being “0.” The memory allocator 260 may connect the second memory controller 250 and the second memory unit 272 based on the second set signal SET2 being “1.” As such, the memory allocator 260 may connect the first memory controller 240 with the first memory unit 271, the third memory unit 273, and the fourth memory unit 274, and may connect the second memory controller 250 with the second memory unit 272 and the fifth memory unit 275.

The set signals SET1 to SETS may be managed as mapping values C1 to C5 at a real memory mapping table RMMT. The mapping values C1 to C5 may indicate mapping information between the memory controllers 240 and 250 and the memory units 271 to 275. Further, the mapping information may indicate memory allocation information associated with the processors 210 and 220 of FIG. 3 according to a demand of a client. The first to fifth mapping values C1 to C5 may respectively correspond to the first to fifth memory units 271 to 275. For example, the first to fifth mapping values C1 to C5 may be 0, 1, 0, 0, and 1.

The number of mapping values of the real memory mapping table RMMT may vary depending on the number of memory units. For example, as illustrated in FIG. 5, in the case where five memory units 271 to 275 exist, five mapping values may be stored in the real memory mapping table RMMT. Mapping values that the real memory mapping table RMMT have may vary depending on the number of memory controllers. For example, in the case where three memory controllers use the memory device 270, a mapping value may be one of 0, 1, and 2.

The real memory mapping table RMMT may be stored in a particular register (e.g., an always-on memory) of the memory system 200. It is understood, however, that one or more exemplary embodiments are not limited thereto. For example, the real memory mapping table RMMT may be stored in an internal register of the memory allocator 260.

As described above, the mapping values C1 to C5 of the real memory mapping table RMMT may vary depending on a demand of a client. Because the set signals SET1 to SETS correspond to the mapping values C1 to C5, the connection between the memory controllers 240 and 250 and the memory units 271 to 275 may vary depending on a demand of a client. As such, the memory units 271 to 275 may be flexibly allocated to the processors 210 and 220 depending on a demand of a client.

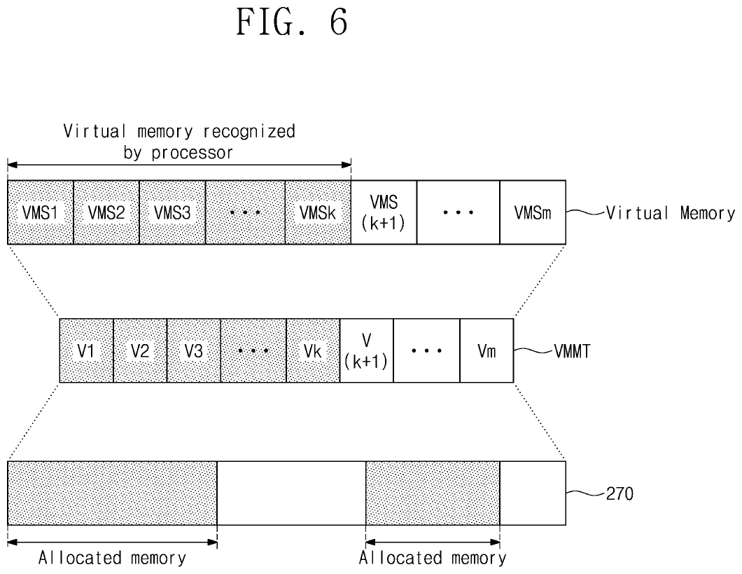

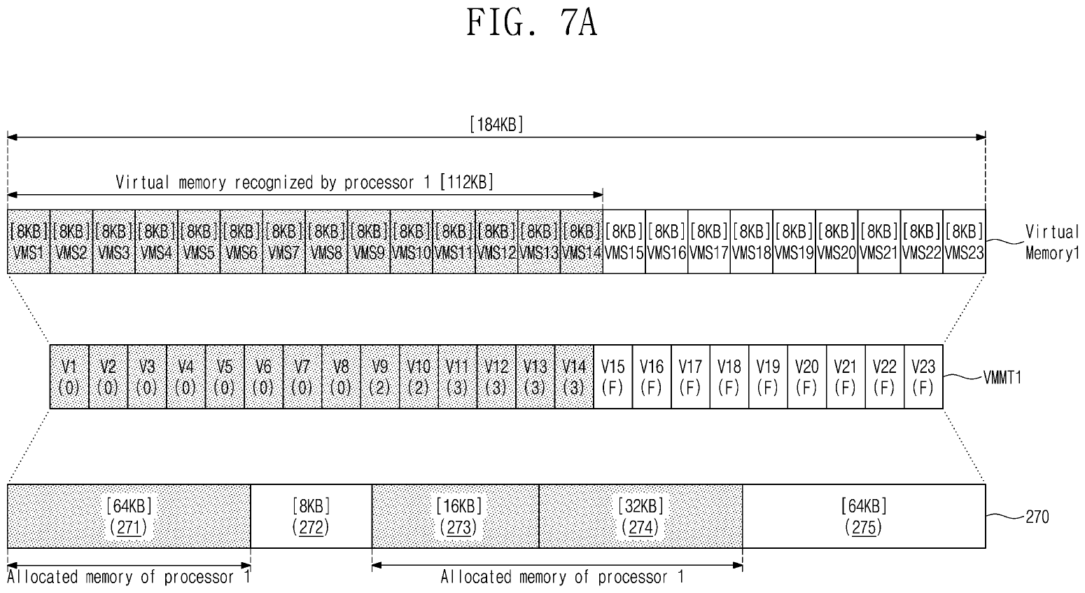

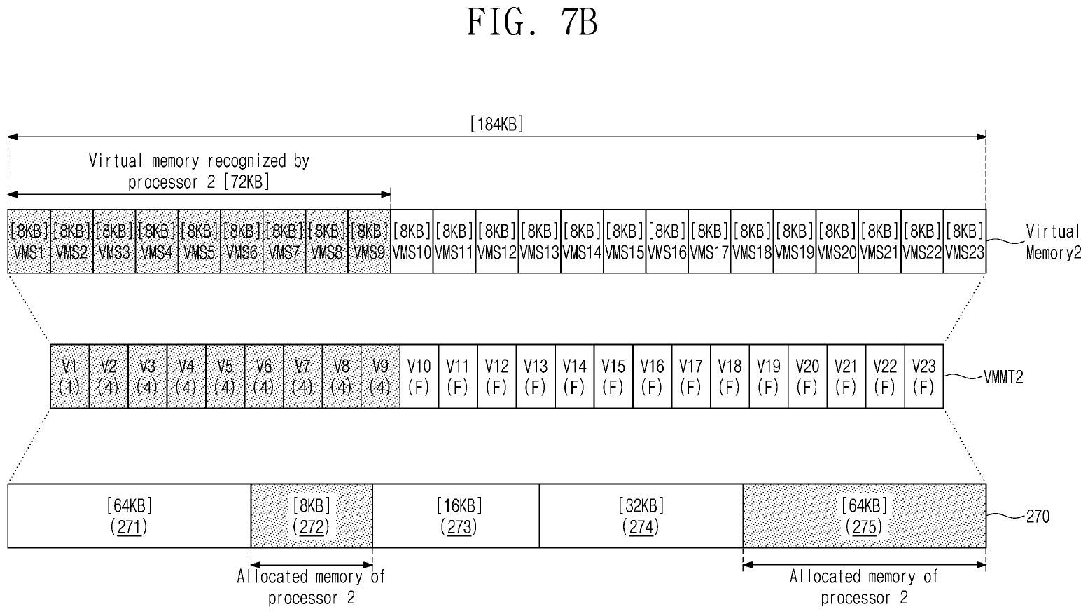

Below, an operation of the memory controllers 240 and 250 of FIG. 3 is more fully described below with reference to FIGS. 6 and 7A to 7B.

FIG. 6 is a diagram for describing an operation of a memory controller of a memory system of FIG. 3. Referring to FIG. 6, a memory controller may manage a virtual memory. The virtual memory may be a memory that is managed by the memory controller so as to correspond to a physical memory of the memory device 270. The memory controller may provide the virtual memory of a size corresponding to an allocated memory size of the memory device 270 to a processor. In this case, the processor may recognize that the virtual memory provided from the memory controller is an actually-allocated memory.

The virtual memory may be divided into first to m-th virtual memory segments VMS1 to VMSm. The total memory size of the virtual memory segments VMS1 to VMSm may correspond to the total memory size of the memory device 270. In an exemplary embodiment, the virtual memory segments VMS1 to VMSm may have a uniform memory size. In this case, the memory size of each of the virtual memory segments VMS1 to VMSm may be equal to or smaller than a minimum memory size of memory sizes that memory units have. Alternatively, the memory size of each of the virtual memory segments VMS1 to VMSm may be one of common divisors of memory sizes that memory units have. For example, as described above with reference to FIG. 3, in the case where a memory size that each of the memory units 271 to 27n of the memory device 270 has is one of 8 KB, 16 KB, 32 KB, and 64 KB, the memory size of each of the virtual memory segments VMS1 to VMSm may be 4 KB or 8 KB.

As described above with reference to FIGS. 4 and 5, in the case where a memory of the memory device 270 is allocated depending on a demand of a client, the memory controller may provide the virtual memory corresponding to the allocated memory size to the processor. For example, as illustrated in FIG. 6, the memory controller may provide the virtual memory of the first to k-th virtual memory segments VMS1 to VMSk (k being an integer less than or equal to m) to the processor so as to correspond to the allocated memory size. As such, the processor may recognize that the virtual memory of the virtual memory segments VMS1 to VMSk is an actually-allocated memory. That is, the virtual memory segments VMS1 to VMSk may be recognized by the processor.

The memory controller may generate a virtual memory mapping table VMMT associated with the virtual memory. The virtual memory mapping table VMMT may include mapping information between the virtual memory and the allocated memory of the memory device 270. That is, the mapping information of the virtual memory mapping table VMMT may indicate a mapping relationship between the virtual memory segments VMS1 to VMSm and the memory units 271 to 27n of the memory device 270 (refer to FIG. 3). The virtual memory mapping table VMMT may be stored in an internal memory of the memory controller, although it is understood that one or more other exemplary embodiments are not limited thereto.

The memory controller may manage the virtual memory mapping table VMMT depending on a demand of a client. In an exemplary embodiment, the memory controller may determine the allocated memory based on required memory information corresponding to a demand of a client (e.g., the set signals SET1 to SETn described above with reference to FIGS. 4 and 5). The memory controller may map (i.e., allocate) the virtual memory onto (or to) a memory of the memory device 270 based on the allocated memory (i.e., at least one of the memory unit 271 to 27n of the memory device 270). As such, the memory controller may manage the mapping information between the virtual memory segments VMS1 to VMSm and the memory units 271 to 27n of the memory device 270.

The virtual memory mapping table VMMT may store mapping values V1 to Vm corresponding to the virtual memory segments VMS1 to VMSm. For example, the first mapping value V1 may indicate a mapping relationship between the first virtual memory segment VMS1 and the memory units 271 to 27n. By way of example, as illustrated in FIG. 6, in the case where the memory of the virtual memory segments VMS1 to VMSm is provided to the processor, the memory controller may store first to k-th mapping values V1 to Vk in the virtual memory mapping table VMMT. In this case, each of the mapping values V1 to Vk may indicate corresponding one of allocated memory units of the memory device 270. Mapping values V(k+1) to Vm corresponding to virtual memory segments VMS(k+1) to VMSm, which are not recognized by the processor, from among the virtual memory segments VMS1 to VMSm may not indicate any memory unit of the memory device 270.

As described above, the memory controller according to an exemplary embodiment may provide the virtual memory to the corresponding processor and may manage the virtual memory mapping table VMMT storing mapping information between the virtual memory and an allocated memory of the memory device 270. The memory controller may allow the virtual memory to correspond to the allocated physical memory by using the virtual memory mapping table VMMT. As such, the memory controller may flexibly provide the processor with a memory that is differently or variably allocated depending on (or according to, based on, etc.) demands of clients.

FIGS. 7A and 7B illustrate examples of operations of memory controllers 240 and 250 of FIG. 3 according to an operation of a memory controller of FIG. 6. In detail, FIG. 7A illustrates an example of an operation of the first memory controller 240, and FIG. 7B illustrates an example of an operation of the second memory controller 250. For convenience of description, as described above with reference to FIG. 5, it is assumed that the memory device 270 includes the first to fifth memory units 271 to 275 having sizes of 64 KB, 8 KB, 16 KB, 32 KB, and 64 KB. Also, it is assumed that, depending on (or based on) a demand of a client, the first memory unit 271, the third memory unit 273, and the fourth memory unit 274 are allocated to the first processor 210 and the second memory unit 272 and the fifth memory unit 275 are allocated to the second processor 220.

Referring to FIGS. 3 and 7A, the first memory controller 240 may manage a first virtual memory so as to correspond to the total memory size of the memory device 270. Because the total memory size of the memory device 270 is 184 KB, the first memory controller 240 may manage the first virtual memory of 184 KB. For example, the first memory controller 240 may manage the first virtual memory by using first to twenty-third virtual memory segments VMS1 to VMS23. Each of the first to twenty-third virtual memory segments VMS1 to VMS23 may be 8 KB.

The first memory controller 240 may generate a first virtual memory mapping table VMMT1 including first to twenty-third mapping values V1 to V23 so as to correspond to the 23 virtual memory segments VMS1 to VMS23. The mapping values V1 to V23 may indicate a mapping relationship between the virtual memory segments VMS1 to VMS23 and the memory units 271 to 275.

As illustrated in FIG. 7A, in the case where the first memory unit 271, the third memory unit 273, and the fourth memory unit 274 of the memory device 270 are allocated to the first processor 210 depending on (or based on) a demand of a client, the memory size allocated to the first processor 210 may be 112 KB. The first memory controller 240 may provide the first processor 210 with the virtual memory of the first to fourteenth virtual memory segments VMS1 to VMS14 so as to correspond to the allocated memory size. As such, the first processor 210 may recognize that the virtual memory of the virtual memory segments VMS1 to VMS14 is an actually allocated memory.

In the example illustrated in FIG. 7A, the first virtual memory segment VMS1 to the fourteenth virtual memory segment VMS14 are selected as a virtual memory to be provided to the first processor 210. It is understood, however, that one or more other exemplary embodiments are not limited thereto. For example, the first memory controller 240 may select 14 virtual memory segments of the 23 virtual memory segments VMS1 to VMS23 in various manners and may provide the virtual memory of the selected virtual memory segments to the first processor 210.

The first memory controller 240 may map the allocated memory units 271, 273, and 274 onto the selected virtual memory segments VMS1 to VMS14. For example, the first memory unit 271 may be mapped onto the first to eighth virtual memory segments VMS1 to VMS8. The third memory unit 273 may be mapped onto the ninth and tenth virtual memory segments VMS9 and VMS10. The fourth memory unit 274 may be mapped onto the eleventh to fourteenth virtual memory segments VMS11 to VMS14. As such, the first memory controller 240 may store “0” indicating the first memory unit 271 as the first to eighth mapping values V1 to V8, “2” indicating the third memory unit 273 as ninth and tenth mapping values V9 and V10, and “3” indicating the fourth memory unit 274 as eleventh to fourteenth mapping values V11 to V14, in the first virtual memory mapping table VMMT1.

The first memory controller 240 may not map any memory unit onto the unselected virtual memory segments VMS15 to VMS23. As such, the first memory controller 240 may store “F” as fifteenth to twenty-third mapping values V15 to V23 in the first virtual memory mapping table VMMT1. It is understood that the mapping values of the first virtual memory mapping table VMMT1 illustrated in FIG. 7A are examples, and one or more other exemplary embodiments are not limited thereto.

As described above, based on a memory allocated to the first processor 210, the first memory controller 240 may provide the first virtual memory to the first processor 210 and may manage the first virtual memory mapping table VMMT1. As such, the first memory controller 240 may provide a flexibly allocated memory even though a memory allocated to the first processor 210 changes depending on a demand of a client.

Referring to FIGS. 3 and 7B, the second memory controller 250 may manage a second virtual memory so as to correspond to the total memory size of the memory device 270. Because the total memory size of the memory device 270 is 184 KB, the second memory controller 250 may manage the second virtual memory of 184 KB. For example, the second memory controller 250 may manage the second virtual memory by using the first to twenty-third virtual memory segments VMS1 to VMS23. Each of the virtual memory segments VMS1 to VMS23 may be 8 KB.

The second memory controller 250 may generate a second virtual memory mapping table VMMT2 including the first to twenty-third mapping values V1 to V23 so as to correspond to the 23 virtual memory segments VMS1 to VMS23. The mapping values V1 to V23 indicate a mapping relationship between the virtual memory segments VMS1 to VMS23 and the memory units 271 to 275.

As illustrated in FIG. 7B, in the case where the second memory unit 272 and the fifth memory unit 275 of the memory device 270 are allocated to the second processor 220 depending on a demand of a client, the memory size allocated to the second processor 220 may be 72 KB. The second memory controller 250 may provide the second processor 220 with the virtual memory of the first to ninth virtual memory segments VMS1 to VMS9 so as to correspond to the allocated memory size. As such, the second processor 220 may recognize that the virtual memory of the virtual memory segments VMS1 to VMS9 is an actually-allocated memory.

In the example illustrated in FIG. 7B, the first virtual memory segment VMS1 to the ninth virtual memory segment VMS9 are selected as a virtual memory to be provided to the second processor 220, but it is understood that one or more other exemplary embodiments are not limited thereto. For example, according to another exemplary embodiment, the second memory controller 250 may select 9 virtual memory segments of the 23 virtual memory segments VMS1 to VMS23 in various manners and may provide the memory of the selected virtual memory segments to the second processor 220.

The second memory controller 250 may map the allocated memory units 272 and 275 onto the selected virtual memory segments VMS1 to VMS9. For example, the second memory unit 272 may be mapped onto the first virtual memory segment VMS1, and the fifth memory unit 275 may be mapped onto the second to ninth virtual memory segments VMS2 to VMS9. As such, the second memory controller 250 may store “1” indicating the second memory unit 272 as the first mapping value V1 and “4” indicating the fifth memory unit 275 as second to ninth mapping values V2 to V9, in the second virtual memory mapping table VMMT2.

The second memory controller 250 may not map any memory unit onto the unselected virtual memory segments VMS10 to VMS23. As such, the second memory controller 250 may store “F” as tenth to twenty-third mapping values V10 to V23 in the second virtual memory mapping table VMMT2. It is understood that mapping values of the second virtual memory mapping table VMMT2 illustrated in FIG. 7B are one example, and one or more other exemplary embodiments are not limited thereto.

As described above, based on a memory allocated to the second processor 220, the second memory controller 250 may provide the second virtual memory to the second processor 220 and may manage the second virtual memory mapping table VMMT2. As such, the second memory controller 250 may provide a flexibly-allocated memory even though a memory allocated to the second processor 220 changes depending on a demand of a client.

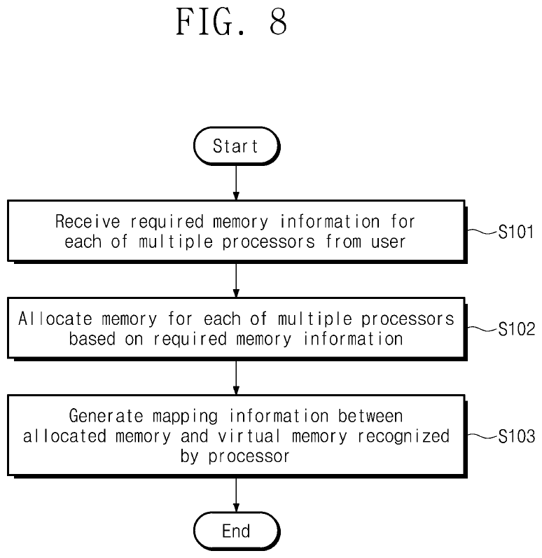

FIG. 8 is a flowchart illustrating an exemplary operation of a memory system 200 of FIG. 3. Referring to FIGS. 3 and 8, in operation S101, the memory system 200 may receive required memory information about each of a plurality of processors from a user (or a client). For example, as described with reference to FIGS. 4 and 5, the received required memory information may be stored and managed in the real memory mapping table RMMT. The required memory information may be provided to the memory allocator 260 as the set signals SET1 to SETn.

In operation S102, the memory system 200 may allocate a memory to each of the plurality of processors based on the required memory information. For example, as described above with reference to FIGS. 4 and 5, the memory allocator 260 may connect memory controllers corresponding to the plurality of processors with memory units of the memory device 270 based on the set signals SET1 to SETn. As such, a memory may be allocated to each processor.

In operation S103, the memory system 200 may generate mapping information between the allocated memory and a virtual memory recognized by the processor. For example, as described above with reference to FIGS. 6 to 7B, each of the memory controllers 240 and 250 may store the mapping information between the allocated memory and the virtual memory in the virtual memory mapping table VMMT.

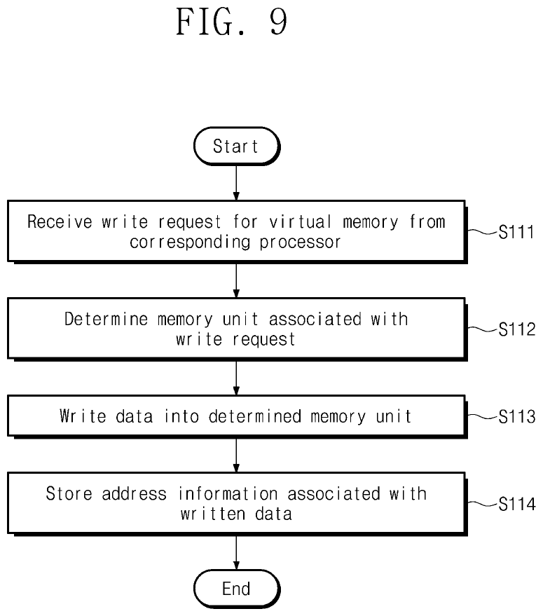

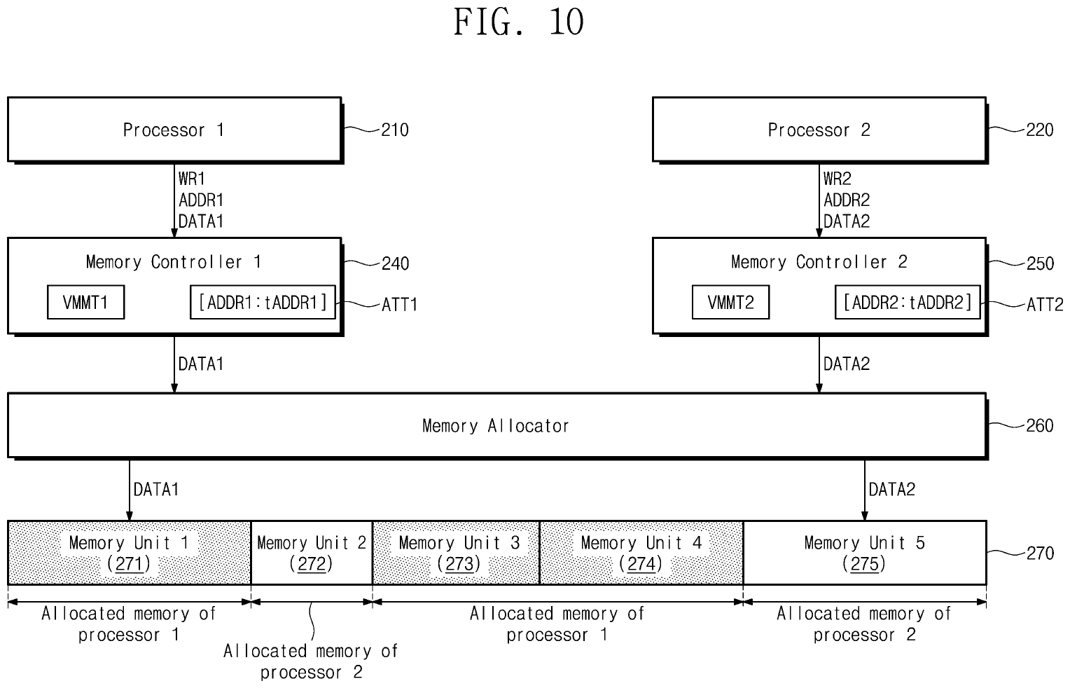

Below, processing by the memory controllers 240 and 250 of FIG. 3 of a memory access request from the processors 210 and 220 is described with reference to FIGS. 9 and 10.

FIG. 9 is a flowchart illustrating a write operation of a memory controller 240 or 250 of FIG. 3. Operations of FIG. 9 may be performed after the memory system 200 allocates a memory through operations of the method illustrated in FIG. 8 and generates mapping information between the allocated memory and a virtual memory.

Referring to FIG. 9, in operation S111, the memory controller may receive a write request for the virtual memory from the corresponding processor. For example, the write request provided to the memory controller may include a write command, data, and an address. Further, the address may indicate at least one of virtual memory segments recognized by the processor.

In operation S112, the memory controller may determine a memory unit associated with the write request. For example, as described above with reference to FIG. 6, the memory controller may determine a memory unit corresponding to a virtual memory segment that the address indicates, based on the mapping information of the virtual memory mapping table VMMT.

In operation S113, the memory controller may write data in the determined memory unit. For example, the memory controller may provide data to the determined memory unit through a communication path established by the memory allocator 260 of FIG. 3. The determined memory unit may store the provided data.

In operation S114, the memory controller may store address information associated with (or corresponding to) the written data. For example, the memory controller may store the address of the memory unit where data are written, so as to correspond to the address provided from the processor. That is, the first memory controller 240 may manage an address of the virtual memory and an address of the memory at which data is actually written.

FIG. 10 is an example illustrating a write operation of a memory system 200 of FIG. 3 according to an operation of FIG. 9. For convenience of description, as described above with reference to FIG. 5, it is assumed that the first memory unit 271, the third memory unit 273, and the fourth memory unit 274 are allocated to the first processor 210, and the second memory unit 272 and the fifth memory unit 275 are allocated to the second processor 220.

Referring to FIG. 10, the first processor 210 may provide a first write command WR1, a first address ADDR1, and first data DATA1 to the first memory controller 240. The first memory controller 240 may determine a memory unit corresponding to the first address ADDR1 from among the first to fifth memory units 271 to 275 based on the mapping information of the first virtual memory mapping table VMMT1. That is, the first memory controller 240 may determine a memory unit corresponding to a virtual memory segment that the first address ADDR1 indicates. For example, the first memory controller 240 may determine the first memory unit 271 as a memory unit corresponding to the first address ADDR1.

As illustrated in FIG. 10, the first memory controller 240 may provide the first data DATA1 to the first memory unit 271 through a communication path established by the memory allocator 260. As such, the first data DATA1 may be written in the first memory unit 271.

The first memory controller 240 may store a first translation address tADDR1 of the first memory unit 271 at which the first data DATA1 is stored, so as to correspond to the first address ADDR1. For example, the first memory controller 240 may store the first address ADDR1 and the first translation address tADDR1 in a first address translation table ATT1. In this case, the first address translation table ATT1 may be an address translation table corresponding to the first memory unit 271. That is, the first memory controller 240 may manage an address translation table for each of the allocated memory units.

The second processor 220 may provide a second write command WR2, a second address ADDR2, and second data DATA2 to the second memory controller 250. The second memory controller 250 may determine a memory unit corresponding to the second address ADDR2 from among the first to fifth memory units 271 to 275 based on the mapping information of the second virtual memory mapping table VMMT2. That is, the second memory controller 250 may determine a memory unit corresponding to a virtual memory segment that the second address ADDR2 indicates. For example, the second memory controller 250 may determine the fifth memory unit 275 as a memory unit corresponding to the second address ADDR2.

As illustrated in FIG. 10, the second memory controller 250 may provide the second data DATA2 to the fifth memory unit 275 through a communication path established by the memory allocator 260. As such, the second data DATA2 may be written in the fifth memory unit 275.

The second memory controller 250 may store a second translation address tADDR2 of the fifth memory unit 275 at which the second data DATA2 is stored, so as to correspond to the second address ADDR2. For example, the second memory controller 250 may store the second address ADDR2 and the second translation address tADDR2 in a second address translation table ATT2.

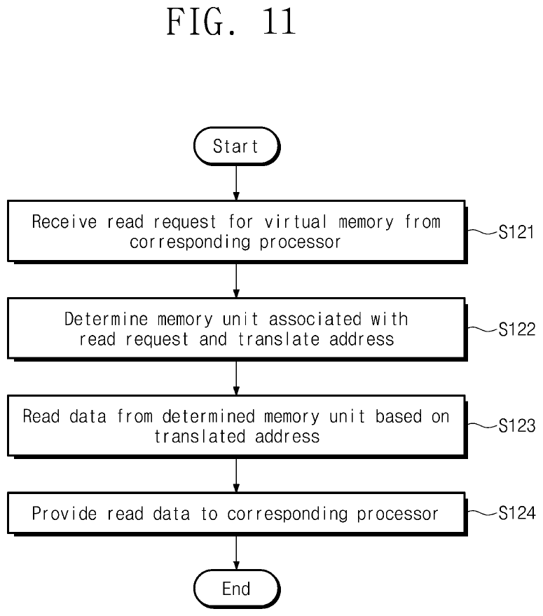

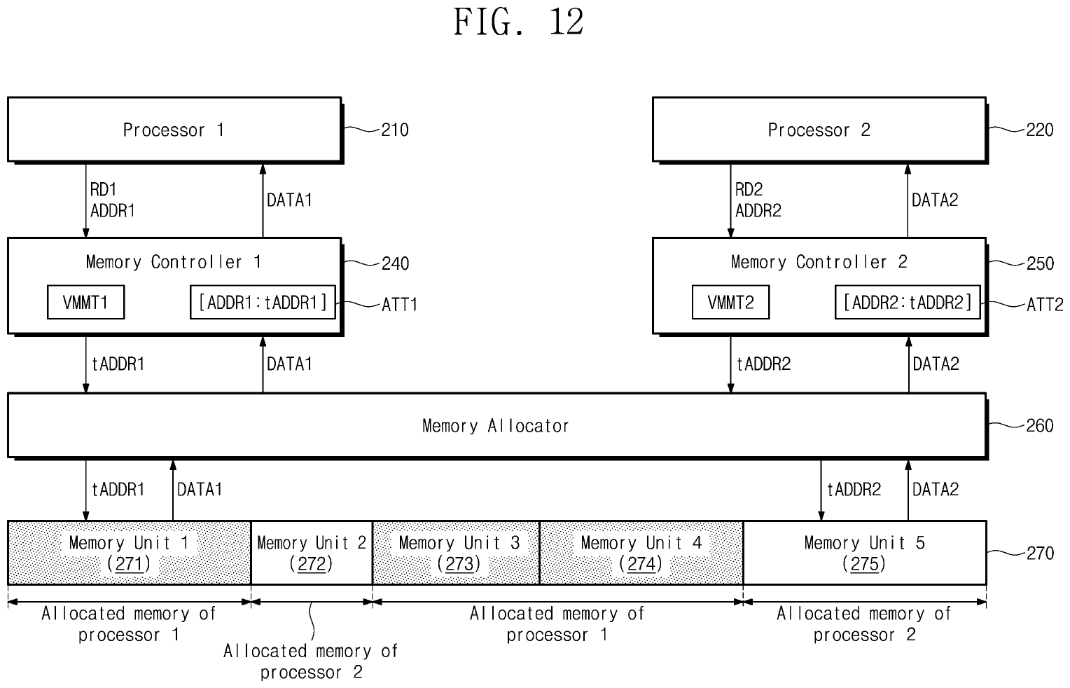

FIG. 11 is a flowchart illustrating a read operation of a memory controller 240 or 250 of FIG. 3. Operations of FIG. 11 may be performed after write operations of FIG. 9 are performed.

Referring to FIG. 11, in operation S121, a memory controller may receive a read request for a virtual memory from the corresponding processor. For example, the read request provided to the memory controller may include a read command and an address. For example, the address may indicate at least one of virtual memory segments recognized by the processor.

In operation S122, the memory controller may determine a memory unit associated with the read request and may translate the address. For example, as described above with reference to FIG. 6, the memory controller may determine a memory unit corresponding to a virtual memory segment that the address indicates, based on the mapping information of the virtual memory mapping table VMMT. For example, the memory controller may translate an address provided from the processor based on an address translation table corresponding to the determined memory unit. As such, the memory controller may obtain a translation address indicating a memory position at which data are stored.

In operation S123, the memory controller may read data from the determined memory unit based on the translation address. For example, the memory controller may provide the translation address to the determined memory unit through a communication path established by the memory allocator 260 of FIG. 3. The determined memory unit may output data based on the provided translation address. In operation S124, the memory controller may provide the read data to the corresponding processor.

FIG. 12 is an example illustrating a read operation of a memory system 200 of FIG. 3 according to an operation of FIG. 11. For convenience of description, as described above with reference to FIG. 10, it is assumed that first data DATA1 is stored in the first memory unit 271 and second data DATA2 is stored in the fifth memory unit 275.

Referring to FIG. 12, the first processor 210 may provide a first read command RD1 and a first address ADDR1 to the first memory controller 240 for the purpose of reading the first data DATA1. The first memory controller 240 may determine the first memory unit 271 as a memory unit corresponding to the first address ADDR1 based on mapping information of the first virtual memory mapping table VMMT1. The first memory controller 240 may translate the first address ADDR1 based on the first address translation table ATT1 corresponding to the determined first memory unit 271. As such, the first memory controller 240 may obtain the first translation address tADDR1.

As illustrated in FIG. 12, the first memory controller 240 may provide the first translation address tADDR1 to the first memory unit 271 through a communication path established by the memory allocator 260 and may read the first data DATA1 stored in the first memory unit 271. The first memory controller 240 may provide the first data DATA1 to the first processor 210.

The second processor 220 may provide a second read command RD2 and a second address ADDR2 to the second memory controller 250 for the purpose of reading the second data DATA2. The second memory controller 250 may determine the fifth memory unit 275 as a memory unit corresponding to the second address ADDR2 based on mapping information of the second virtual memory mapping table VMMT2. The second memory controller 250 may translate the second address ADDR2 based on the second address translation table ATT2 corresponding to the determined fifth memory unit 275. As such, the second memory controller 250 may obtain the second translation address tADDR2.

As illustrated in FIG. 12, the second memory controller 250 may provide the second translation address tADDR2 to the fifth memory unit 275 through a communication path established by the memory allocator 260 and may read the second data DATA2 stored in the fifth memory unit 275. The second memory controller 250 may provide the second data DATA2 to the second processor 220.

As described above, the first processor 210 may access the allocated memory of the memory device 270 through the first memory controller 240, and the second processor 220 may access the allocated memory of the memory device 270 through the second memory controller 250. In this case, because the processors 210 and 220 access the allocated memories by using different memory controllers, the processors 210 and 220 may not access the allocated memory through one shared memory controller. As such, even though the processors 210 and 220 access the allocated memories in parallel (or at the same time), a traffic congestion due to sharing a memory controller may not occur. Accordingly, the memory system 200 may flexibly allocate memories to the processors 210 and 220 depending on a demand of a client and may prevent the traffic congestion in the case of accessing the allocated memories.

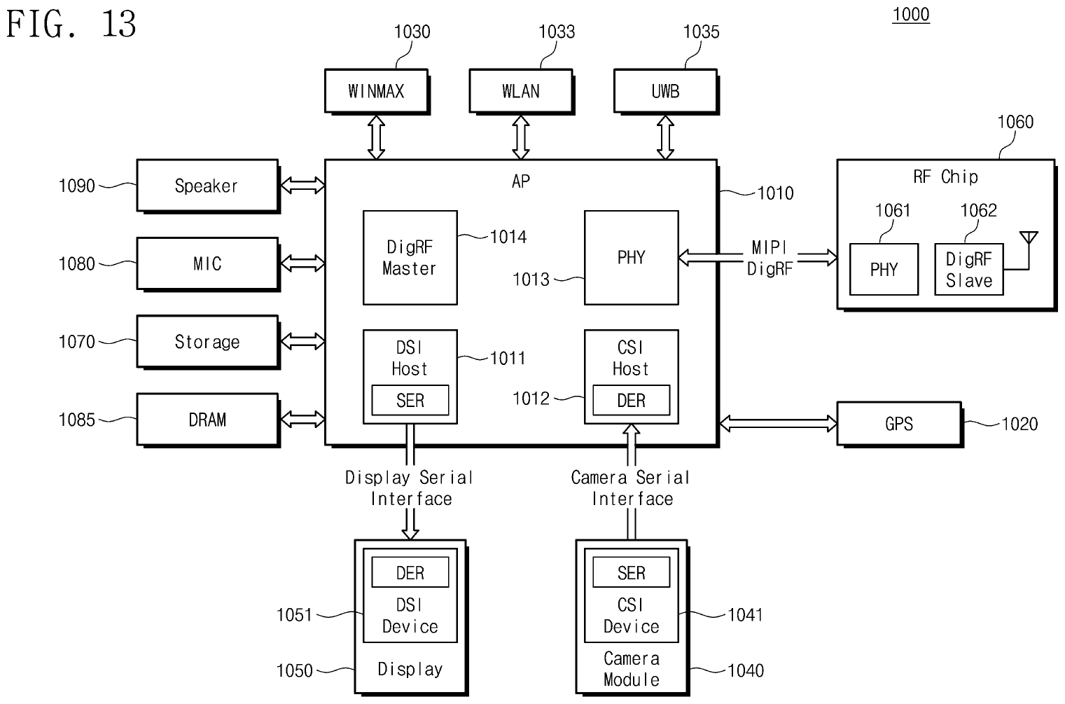

FIG. 13 is a block diagram illustrating an electronic device 1000 including a memory system according to an exemplary embodiment.

An electronic device 1000 may be implemented with a data processing device that is capable of using or supporting an interface protocol proposed by the MIPI alliance. For example, the electronic device 1000 may be one of electronic devices such as a portable communication terminal, a personal digital assistant (PDA), a portable media player (PMP), a smartphone, a tablet computer, a wearable device, and an electric vehicle.

Referring to FIG. 13, the electronic device 1000 may include an application processor 1010, a camera module 1040, and a display 1050. The application processor 1010 may include a display serial interface (DSI) host 1011, a camera serial interface (CSI) host 1012, a physical layer 1013, and a DigRF master 1014.

For example, the application processor 1010 may be implemented with the memory system 100 or 200 described above with reference to FIGS. 1 2A to 2B, 3 to 6, 7A to 7B, and 9 to 12. In this case, the application processor 1010 may include a plurality of processors performing various functions and an internal memory device. The application processor 1010 may allocate a memory of the internal memory device to each of the processors depending on a demand of a client.

The DSI host 1011 may communicate with a DSI device 1051 of the display 1050 through the DSI. For example, a serializer SER may be implemented in the DSI host 1011. Further, a deserializer DES may be implemented in the DSI device 1051.

The CSI host 1012 may communicate with a CSI device 1041 of the camera module 1040 through the CSI. For example, the camera module 1040 may include an image sensor. For example, a deserializer DES may be implemented in the CSI host 1012, and a serializer SER may be implemented in the CSI device 1041.

The electronic device 1000 may further include a radio frequency (RF) chip 1060 that communicates with the application processor 1010. The RF chip 1060 may include a physical layer 1061 and a DigRF slave 1062. For example, the physical layer 1061 of the RF chip 1060 and the physical layer 1013 of the application processor 1010 may exchange data with each other through the DigRF interface supported by the MIPI alliance.

The electronic device 1000 may include a storage 1070 and a DRAM 1085. The storage 1070 and the DRAM 1085 may store data received from the application processor 1010. Also, the storage 1070 and the DRAM 1085 may provide the stored data to the application processor 1010.

The electronic device 1000 may communicate with an external device/system through communication modules, such as a worldwide interoperability for microwave access (WiMAX) 1030, a wireless local area network (WLAN) 1033, and an ultra-wideband (UWB) 1035. The electronic device 1000 may further include a microphone 1080 and a speaker 1090 for the purpose of processing voice information. The electronic device 1000 may further include a global positioning system (GPS) device 1020 for processing position information.

According to one or more exemplary embodiments, there may be provided a memory system that reduces costs by minimizing a memory size of an internal memory under the condition that memory sizes required by clients with regard to a plurality of processors are satisfied.

Also, according to one or more exemplary embodiments, there may be provided a memory system capable of allocating a memory flexibly to a plurality of processors depending on a demand of a client.

Also, according to one or more exemplary embodiments, even though a plurality of processors access allocated memories in parallel, a traffic congestion due to sharing a memory controller may not occur.

While the inventive concept(s) has been described above with reference to exemplary embodiments thereof, it will be apparent to those of ordinary skill in the art that various changes and modifications may be made thereto without departing from the spirit and scope of the inventive concept(s) as set forth at least in the following claims.

What is claimed is:

1. A memory system comprising:
a memory device comprising a plurality of memory units;
a first memory controller configured to access the plurality of memory units;
a second memory controller configured to access the plurality of memory units;
a memory allocator configured to, based on set signals, connect a first memory unit of the plurality of memory units to the first memory controller and connect a second memory unit of the plurality of memory units to the second memory controller;
a first processor configured to use the first memory unit through the first memory controller; and
a second processor configured to use the second memory unit through the second memory controller.

2. The memory system of claim 1, wherein the memory allocator comprises:
a first selection circuit configured to select a first communication path between the first memory unit and the first memory controller based on a first set signal among the set signals; and
a second selection circuit configured to select a second communication path between the second memory unit and the second memory controller based on a second set signal among the set signals.

3. The memory system of claim 1, wherein the first memory controller is further configured to provide, to the first processor, a virtual memory corresponding to the first memory unit.

4. The memory system of claim 3, wherein:
the virtual memory is divided into at least one segment; and
the first memory controller is further configured to manage a virtual memory mapping table storing mapping information between the at least one segment and the first memory unit.

5. The memory system of claim 4, wherein, based on the first processor providing an access request for the virtual memory, the first memory controller is further configured to determine the first memory unit corresponding to the virtual memory from among the plurality of memory units based on the virtual memory mapping table and to process the access request through the determined first memory unit.

6. The memory system of claim 1, wherein the set signals have different set values with respect to each of a plurality of clients using the memory system.

7. The memory system of claim 6, wherein the memory device is implemented to have a maximum value of memory sizes of the memory device that the clients require, respectively.

8. The memory system of claim 1, further comprising:
a main processor configured to manage a real memory mapping table storing the set signals.

9. The memory system of claim 1, wherein each of the plurality of memory units comprises memory cells of a pre-set size.

10. A memory system comprising:
a memory device comprising a plurality of memory units;
a plurality of memory controllers configured to access the plurality of memory units;
a plurality of processors configured to use the memory device through a corresponding memory controller among the plurality of memory controllers; and
a memory allocator configured to, based on set signals, connect at least one memory unit among the plurality of memory units to a first memory controller among the plurality of memory controllers,
wherein a first processor among the plurality of processors is configured to use the at least one memory unit through the first memory controller.

11. The memory system of claim 10, wherein the first memory controller is configured to provide, to the first processor, a virtual memory corresponding to the at least one memory unit.

12. The memory system of claim 11, wherein:
the virtual memory is divided into segments having a particular size; and
the first memory controller is further configured to manage mapping information between each of the segments of the virtual memory and the at least one memory unit.

13. The memory system of claim 12, wherein the particular size that each of the segments has corresponds to a common divisor of memory sizes that the plurality of memory units have.

14. The memory system of claim 12, wherein, based on the first processor providing an access request for the virtual memory, the first memory controller is further configured to determine a memory unit corresponding to the virtual memory from among the at least one memory unit based on the mapping information and to process the access request through the determined memory unit.

15. The memory system of claim 10, wherein the set signals have different set values with respect to each of a plurality of clients using the memory system.

16. The memory system of claim 15, wherein the memory device is implemented to have a maximum value of memory sizes of the memory device that the clients require, respectively.

17. An operating method of a memory system that includes a plurality of memory controllers capable of accessing a plurality of memories, each having a pre-set size, and a plurality of processors, the method comprising:
obtaining required memory information about each of the plurality of processors;
allocating, based on the required memory information, a first memory among the plurality of memories to a first processor of the plurality of processors; and
generating, at a first memory controller corresponding to the first processor from among the plurality of memory controllers, mapping information between the allocated first memory and a virtual memory recognized by the first processor.

18. The method of claim 17, further comprising:
determining, at the first memory controller, the first memory corresponding to the virtual memory based on the mapping information, based on a write request for the virtual memory from the first processor;
writing data in the determined first memory; and
storing address information associated with the written data.

19. The method of claim 17, further comprising:
determining, at the first memory controller, the first memory corresponding to the virtual memory based on the mapping information, based on a read request for the virtual memory from the first processor;
reading data from the determined first memory; and
providing, at the first memory controller, the read data to the first processor.

20. The method of claim 17, further comprising:
allocating, based on the required memory information, a second memory among the plurality of memories to a second processor among the plurality of processors; and
generating, at a second memory controller corresponding to the second processor from among the plurality of memory controllers, mapping information between the allocated second memory and a virtual memory recognized by the second processor.
